(19) United States
(12) Patent Application Publication
(10) Pub. No.: US 2007/0245850 A1
(43) Pub. Date: Oct. 25, 2007

(54) Disposable handle bar grip arrangement

(76) Inventor: Liandy Ramali, Monterey Park, CA (US)

Correspondence Address: Raymond Y. Chan;Suite 128, 108 N. Ynez Avenue, Monterey Park, CA, 91754, US

(21) Appl. No.: 11/821,471

(22) Filed: Jun. 21, 2007

Related U.S. Application Data
(63) Continuation-in-part of application No. 11/402,984, filed on Apr. 11, 2006.

(51) Int. Cl. B62B 5/00

(52) U.S. Cl. 74/551.9

(57) ABSTRACT

A disposable handle bar gripping arrangement for a handle bar includes an elongated gripping sheet, and an adhesive film. The elongated gripping sheet has a first longitudinal edge defining a first longitudinal portion and an opposed second longitudinal edge defining a second longitudinal portion, wherein the gripping sheet has a width, which defines between the first and second longitudinal edges, at least larger than the circumferential size of the handle bar. The adhesive film which is provided along the first longitudinal portion of the gripping sheet and is arranged in such a manner that when the gripping sheet is rolled to detachably attach the adhesive film along the second longitudinal portion of the gripping sheet to substantially retain the first longitudinal portion along the second longitudinal portion in position, the gripping sheet forms an elongated tubular wrap, whereby, a user is able to warp the gripping sheet around the handle bar.

### CROSS REFERENCE OF RELATED APPLICATION

This is a Continuous-In-Part application of a non-provisional application having an application Ser. No. 11/402,984 and filing date of Apr. 11, 2006.

### BACKGROUND OF THE PRESENT INVENTION

1. Field of Invention

The present invention relates to a grip, and more particularly to a disposable handle bar gripping arrangement which is adapted for detachably wrapping a handle bar for preventing unwanted substances, such as dirt and germs, from contacting with a user who needs to grip on the handle bar.

2. Description of Related Arts

A conventional gripping bar, such as a handle bar for a shopping cart, usually comprises an elongated main body which forms part of a lager structure for a user to grip thereon. For example, for a typical user of a shopping cart, a user is able to grip on the shopping cart and push the cart to whatever destination the user desires.

Alternatively, a handle bar installed on public transport, such as a handrail installed in a bus, is designed for passengers to hold on it so that when the bus moves, the passengers are able to balance themselves while standing or sitting in the bus. This kind of handle bar has widely been utilized in many occasions.

A major problem for these conventional handle bars is that since they are designed for public use, it is extremely easy for them to come into contact with such unwanted substances as dirt or contaminated residuals. As a result, when subsequent users come to grip on the handle bar, their hands will come into contact with such unwanted substances. As a result, handle bars may become the medium for causing poor public hygiene or even transmitting infectious diseases.

These consequences may become more adverse when one takes into account the fact that in many stores where shopping carts are extensively utilized, there exist a large number of infants or children who are intentionally placed on the shopping carts by their parents. Their reason is obvious, but given the poor hygiene condition of the handle bars, those infants or children are at high risk of contacting those contaminated or infectious substances.

In particular, in those areas where highly infectious diseases are prevalent, handle bars can become a significant source of medium for communicating diseases. For example, SARS and bird flu can be communicated easily by handle bars.

### SUMMARY OF THE PRESENT INVENTION

A main object of the present invention is to provide a disposable handle bar gripping arrangement which is adapted for enclosing a handle bar for preventing unwanted substances, such as dirt, from contacting with a user who needs to grip on the handle bar.

Another object of the present invention is to provide a disposable handle bar gripping arrangement which is made of durable and germ-resistant materials for effectively isolating unwanted substances on the handle bar from user's hands.

Another object of the present invention is to provide a disposable handle bar gripping arrangement which is easy to use, and convenient to carry so as to facilitate widespread application of the present invention. Moreover, the present invention is optimal for use in a wide variety of circumstances.

Another object of the present invention is to provide a disposable handle bar gripping arrangement which is adapted to promote general public hygiene in society.

Accordingly, in order to accomplish the above objects, the present invention provides a disposable handle bar gripping arrangement for a handle bar having a circumferential size, comprising:

an elongated gripping sheet, which is made of germ-resistant material, having a first longitudinal edge defining a first longitudinal portion and an opposed second longitudinal edge defining a second longitudinal portion, wherein the gripping sheet has a width, which defines between the first and second longitudinal edges, at least larger than the circumferential size of the handle bar; and

an adhesive film which is provided along the first longitudinal portion of the gripping sheet and is arranged in such a manner that when the gripping sheet is rolled to detachably attach the adhesive film along the second longitudinal portion of the gripping sheet to substantially retain the first longitudinal portion along the second longitudinal portion in position, the gripping sheet forms an elongated tubular wrap;

whereby, a user is able to warp the gripping sheet around the handle bar by detachably attaching the first longitudinal portion of the gripping sheet along the second longitudinal portion thereof via the adhesive film so as to enclose the handle bar within the elongated tubular wrap, such that the disposable handle bar gripping arrangement forms a germ barrier to resist the germ on the handle bar being directly contacted with the hand of the user, and after the disposable handle bar gripping arrangement is used, the user is able to peel the adhesive film from the second longitudinal portion of the gripping sheet to detach the first longitudinal portion of the gripping sheet along the second longitudinal portion thereof for being disposed.

These and other objectives, features, and advantages of the present invention will become apparent from the following detailed description, the accompanying drawings, and the appended claims.

### BRIEF DESCRIPTION OF THE DRAWINGS

FIG. 1 is a schematic diagram of the disposable handle bar gripping arrangement according to a preferred embodiment of the present invention.

FIG. 2 is a perspective view of the disposable handle bar gripping arrangement according to the above preferred embodiment of the present invention.

FIG. 3 is a sectional side view of the disposable handle bar gripping arrangement according to the above preferred embodiment of the present invention.

FIG. 4 is a schematic diagram of a disposable handle bar gripping arrangement according to the above preferred embodiment of the present invention, illustrating that the disposable handle bar gripping arrangement is normally stored in a grip dispenser.

FIG. 5 is an alternative mode of the disposable handle bar gripping arrangement according to the above preferred embodiment of the present invention.

FIG. 6A to FIG. 6C are schematic diagrams of the disposable handle bar gripping arrangement according to the above preferred embodiment of the present invention.

FIG. 7 is a perspective view of a disposable handle bar grip arrangement according to a second preferred embodiment of the present invention, illustrating the disposable handle bar grip arrangement being mounted along a hand bar of a shopping cart.

FIG. 8 is a perspective view of the disposable handle bar grip arrangement in an extension position according to the second preferred embodiment of the present invention.

FIG. 9 is a perspective view of the disposable handle bar grip arrangement in a retraction position according to the second preferred embodiment of the present invention.

FIG. 10 illustrates a first alternative mode of the disposable handle bar grip arrangement in an extension position according to the second preferred embodiment of the present invention.

FIG. 11 illustrates a second alternative mode of the disposable handle bar grip arrangement in an extension position according to the second preferred embodiment of the present invention.

### DETAILED DESCRIPTION OF THE PREFERRED EMBODIMENT

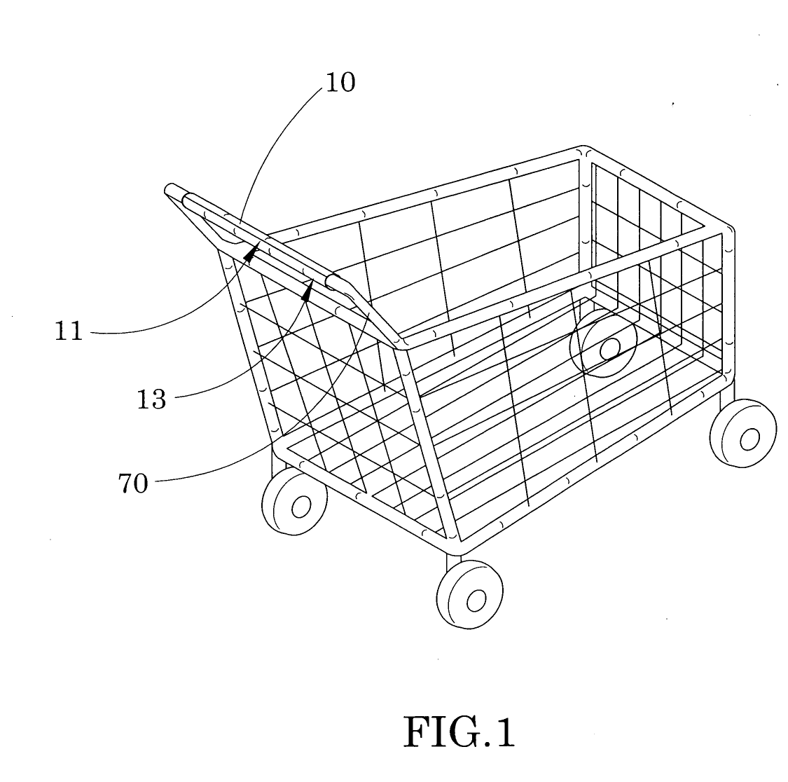

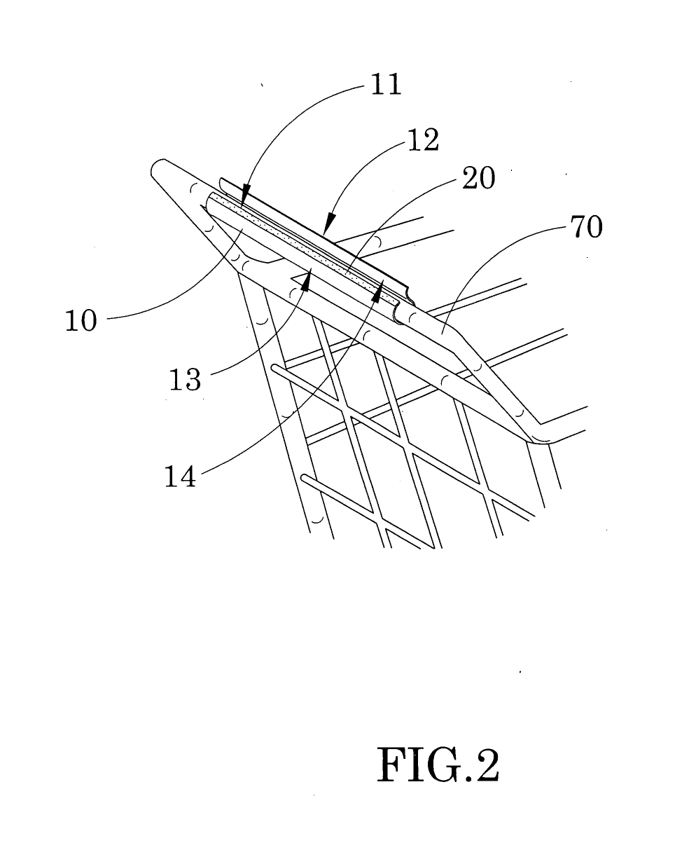

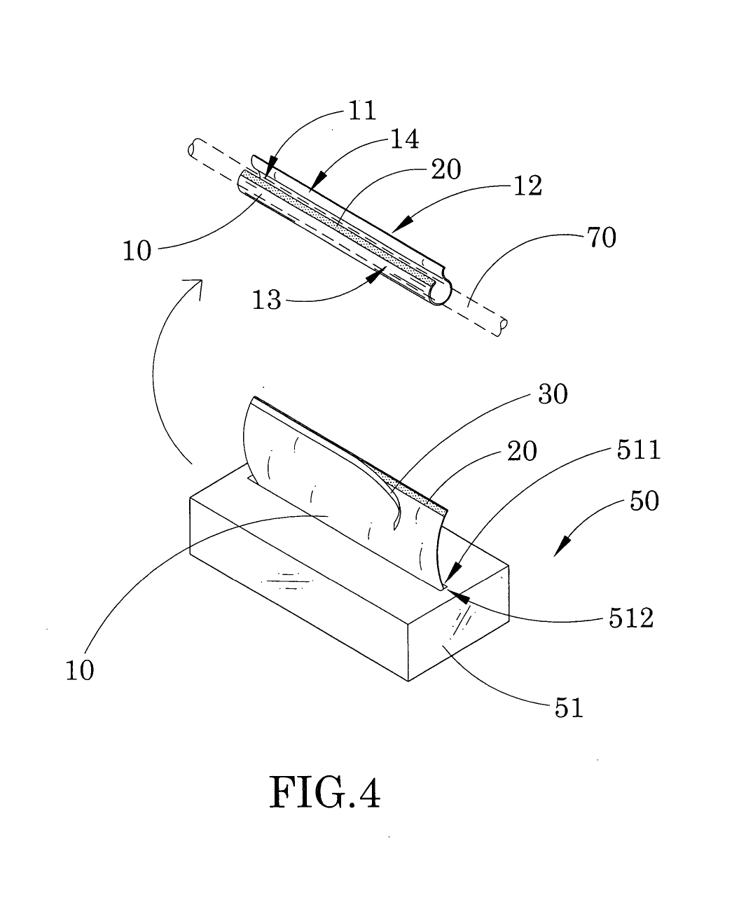

Referring to FIG. 1 to FIG. 4 of the drawings, a disposable handle bar gripping arrangement for a handle bar 70 having a predetermined circumferential size is illustrated, in which the disposable handle bar gripping arrangement comprises an elongated gripping sheet 10, and an adhesive film 20.

The elongated gripping sheet 10, which is made of germ-resistant material, has a first longitudinal edge 11 defining a first longitudinal portion and an opposed second longitudinal edge 12 defining a second longitudinal portion, wherein the gripping sheet 10 has a width, which defines between the first and second longitudinal edges 11, 12, at least larger than the circumferential size of the handle bar 70 and a width of two hands of a user of the present invention.

The adhesive film 20 is provided along the first longitudinal portion of the gripping sheet 10 and is arranged in such a manner that when the gripping sheet 10 is rolled to detachably attach the adhesive film 20 along the second longitudinal portion of the gripping sheet 10 to substantially retain the first longitudinal portion along the second longitudinal portion in position, the gripping sheet 10 forms an elongated tubular wrap, whereby the user is able to wrap the gripping sheet 10 around the handle bar 70 by detachably attaching the first longitudinal portion of the gripping sheet 10 along the second longitudinal portion thereof via the adhesive film 20 so as to enclose the handle bar 70 within the elongated tubular wrap, such that the disposable handle bar gripping arrangement forms a germ barrier to resist the germ on the handle bar 70 being directly contacted with the hand of the user, and after the disposable handle bar gripping arrangement is used, the user is able to peel the adhesive film 20 at the second longitudinal portion of the gripping sheet 10 to detach the first longitudinal portion of the gripping sheet 10 along the second longitudinal portion thereof for being disposed. Since the width of the elongated gripping sheet 10 is longer than a width of the two hands, the elongated gripping sheet 10 is adapted for isolating the hands of the user from the handle bar 70.

According to the preferred embodiment of the present invention, the elongated gripping sheet 10 is made of durable materials which does not lose its strength when contacting with water, while the materials is capable of forming a physical barrier for isolating the unwanted substances from the user's hands. Accordingly, the elongated gripping sheet 10 can be made of paper fiber, plastic film or any non-porous sterile paper which have sufficient strength and elasticity for wrapping around the handle bar 70.

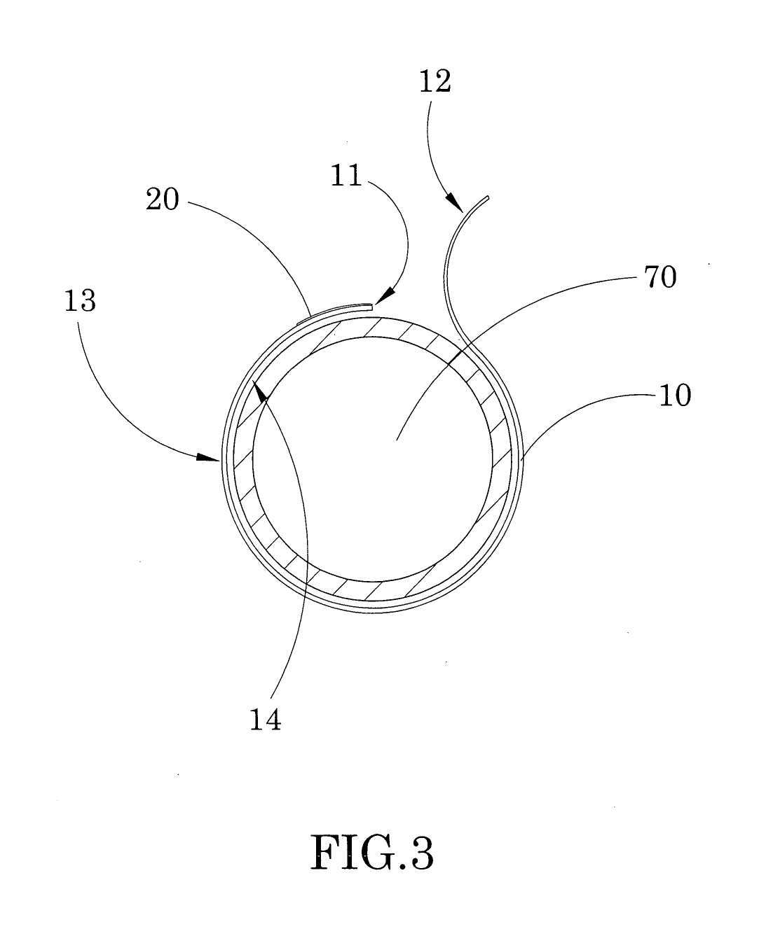

As shown in FIG. 3 of the drawings, the elongated gripping sheet 10 has an outer gripping side 13 and an inner enclosure side 14 opposed to the outer gripping side 13, wherein the adhesive film 20 is preferably applied on the outer gripping side 13 of the elongated gripping sheet 10 at the first longitudinal portion thereof in such a manner that when the elongated gripping sheet 10 is rolled around the handle bar 70, the second longitudinal portion at the inner enclosure side 14 of the elongated gripping sheet 10 is arranged to overlap on the first longitudinal portion of the outer gripping side 13 so as to detachably and overlappedly attach on the adhesive film 20 for securely wrapping around the handle bar 70.

Alternatively, the adhesive film 20 can be applied on the inner enclosure side 14 of the elongated gripping sheet 10 at the first longitudinal portion thereof in such a manner that when the elongated gripping sheet 10 is rolled around the handle bar 70, the first longitudinal portion at the inner enclosure side 14 of the elongated gripping sheet 10 is arranged to overlap on the second longitudinal portion at the outer gripping side 13 so as to detachably and overlappedly attach on the adhesive film 20 for securely wrapping around the handle bar 70.

In order to protect the adhesive film 20 until use, the disposable handle bar gripping arrangement further comprises a protective member 30 detachably and overlappedly attached on the adhesive film 20 in such a manner that the protective member 30 is normally overlapping on the adhesive film 20 for preventing an adhesive ability thereof from deteriorating, and when the user wishes to use the disposable handle bar gripping arrangement of the present invention, he or she is able to easily detach the protective member 30 from the adhesive film 20 for allowing the adhesive film 20 to detachably attach on the second longitudinal portion of the elongated gripping sheet 10. It is worth mentioning that the protective member 30 is preferably embodied as wax paper for effectively isolating the adhesive film 20 from contacting with ambient environment before the disposable handle bar gripping arrangement of the present invention is to be used.

In line with the object of promoting general hygiene, the elongated gripping sheet 10 of the disposable handle bar gripping arrangement is pre-sanitized so as to ensure maximum hygiene condition of the present invention when the disposable handle bar gripping arrangement is being used. After all, if the elongated gripping sheet 10 is in poor hygiene condition, there is little point in using it for wrapping around the handle bar 70 at an attempt to prevent the user from contacting unwanted substances.

As a result, the disposable handle bar gripping arrangement can be contained and packaged in a grip dispenser 50 having a dispenser body 51 which has a receiving cavity 511 and a retrieving opening 512 communicating with the receiving cavity 511, wherein a plurality of disposable handle bar gripping arrangement is normally received in the receiving cavity 512 and is adapted for being retrieved via the retrieving opening 512. In such a situation, unused disposable handle bar gripping arrangements are safely disposed in the grip dispenser 50. Thus, the disposable handle bar gripping arrangement and the grip dispenser 50 form a disposable handle bar gripping set for convenient use by the user of the present invention.

From the above descriptions, it can be shown that the disposable handle bar gripping arrangement of the present invention is extremely easy to use. The user could simply retrieve a disposable handle bar gripping arrangement from the grip dispenser 50, remove the protective member 30, and wrap the elongated gripping sheet 10 around the handle bar 70 and press the first longitudinal portion against the adhesive film 20 for detachably attaching the disposable handle bar gripping arrangement onto the handle bar 70. After use, the disposable handle bar gripping arrangement can be easily disposed so as to leave the, say, shopping cart, ready for use by other customers. It is also worth mentioning that the present invention is optimal for use in a wide variety of circumstances in which gripping handle bar 70 is at stake. For example, it can utilized for shopping carts or in buses.

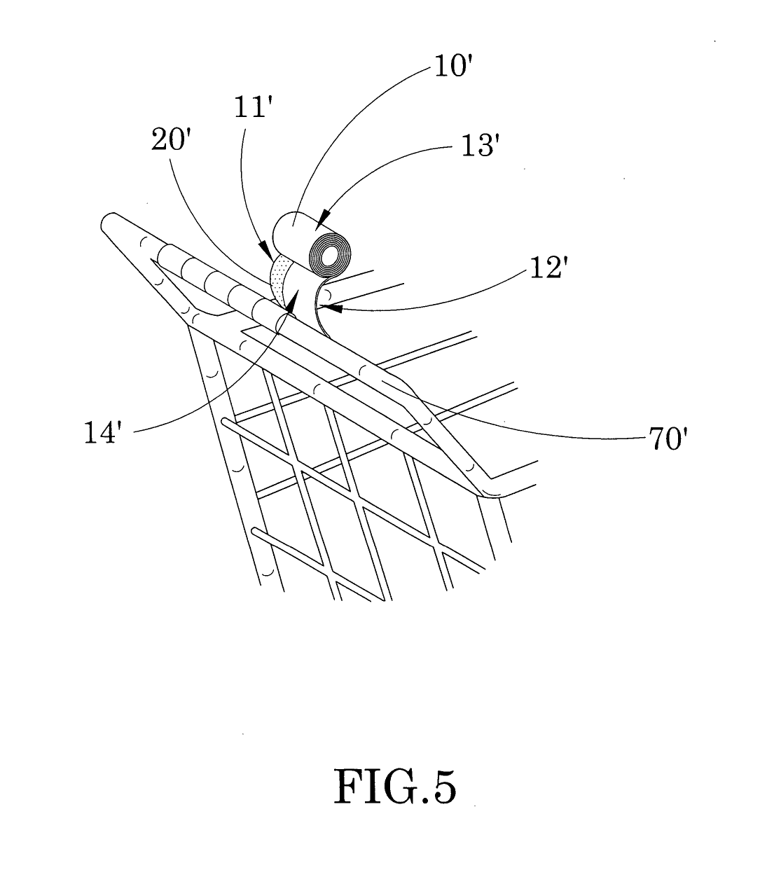

Referring to FIG. 5 of the drawings, an alternative mode of the disposable handle bar gripping arrangement according to the preferred embodiment of the present invention is illustrated. The alternative mode is similar to the preferred embodiment except the gripping sheet 10′ and its use. According to the alternative mode, the disposable handle bar gripping arrangement is also for a handle bar 70′ having a predetermined circumferential size, and comprises an elongated gripping sheet 10′ and an adhesive film 20′.

The elongated gripping sheet 10′, which is made of germ-resistant material, having a first longitudinal edge 11′ defining a first longitudinal portion and an opposed second longitudinal edge 12′ defining a second longitudinal portion, wherein the gripping sheet 10′ has a width, which is defined between the first and second longitudinal edges 11′, 12′, and has a length shorter than a circumferential size of said handle bar 70′.

The adhesive film 20′ is provided along the first longitudinal portion of the gripping sheet 10′ and is arranged in such a manner that when the gripping sheet 10′ is arranged to repetitively roll around the handle bar 70′ along its longitudinal direction, wherein for each turn of the rolling of the gripping sheet 10′ around the handle bar 70′, the first longitudinal portion is arranged to detachably attach on the adhesive film 20′ along the second longitudinal portion of the gripping sheet 10′ to substantially retain the first longitudinal portion along the second longitudinal portion in position, while the gripping sheet 10′ forms a tubular wrap along the handle bar 70′, whereby, a user is able to wrap the gripping sheet 10′ around the handle bar 70′ by repetitively and detachably attaching the first longitudinal portion of the gripping sheet 10′ on the second longitudinal portion for each turn of roll by the gripping sheet 10′ so as to enclose the handle bar 70′ within the elongated tubular wrap, such that the disposable handle bar gripping arrangement forms a germ barrier to resist the germ on the handle bar 70′ being directly contacted with the hand of the user, and after the disposable handle bar gripping arrangement is used, the user is able to peel the adhesive film 20′ from the second longitudinal portion of the gripping sheet 10′ to detach the first longitudinal portion of the gripping sheet 10′ along the second longitudinal portion thereof for being disposed.

Moreover, as shown in FIG. 5 of the drawings, the elongated gripping sheet 10′ also has an outer gripping side 13′ and an inner enclosure side 14′ opposed to the outer gripping side 13′, wherein the adhesive film 20′ is applied on the inner gripping side 14′ of the elongated gripping sheet 10′ at the first longitudinal portion thereof in such a manner that when the elongated gripping sheet 10′ is rolled around the handle bar 70′, the first longitudinal portion at the inner enclosure side 14′ of the elongated gripping sheet 10′ is arranged to overlap on the second longitudinal portion at the outer gripping side 13′ so as to detachably and overlappedly attach on the adhesive film 20′ for securely wrapping around the handle bar 70′ by repetitively rolling around the handle bar 70′.

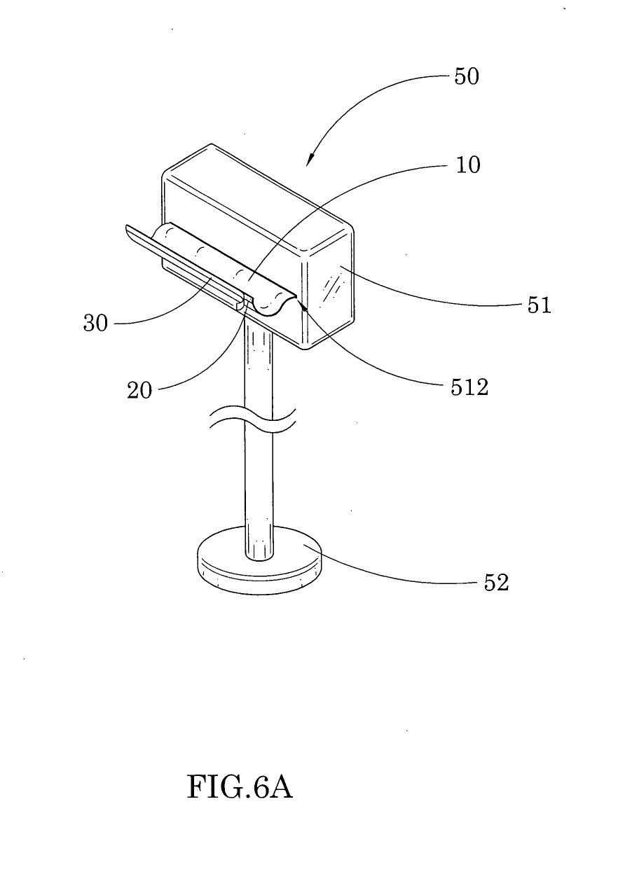

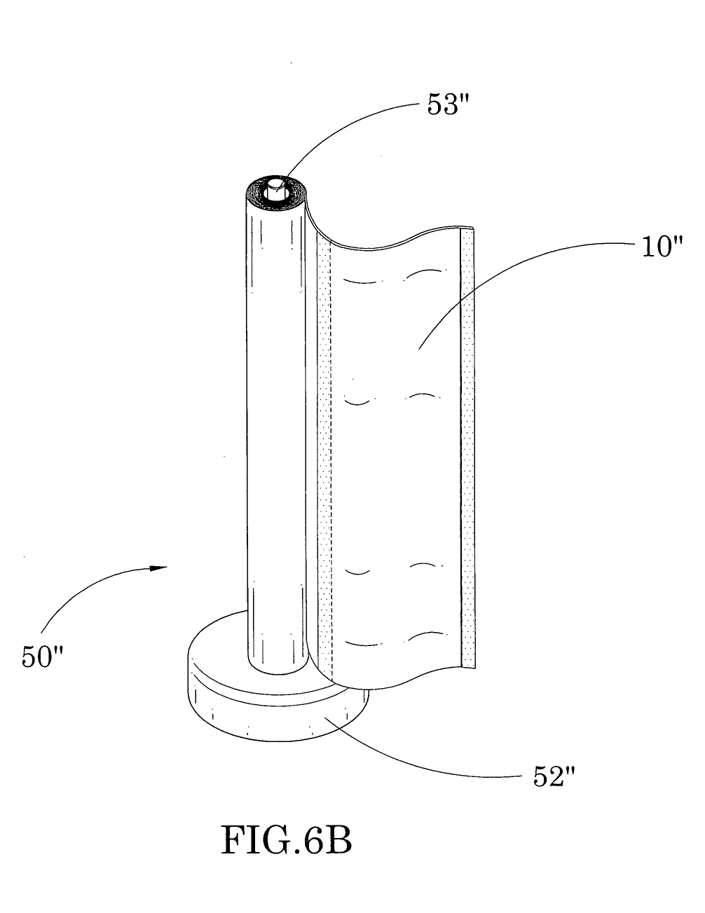

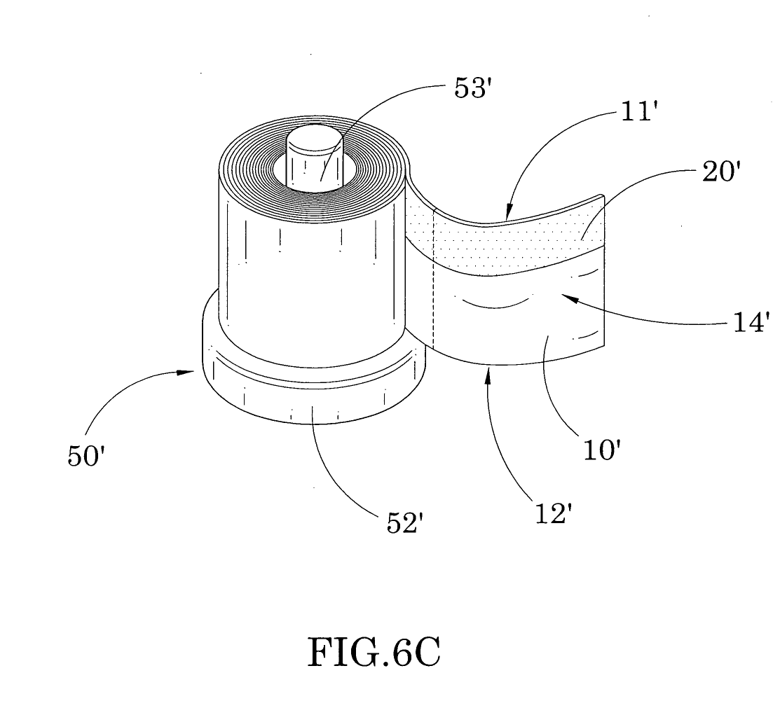

Referring to FIG. 6C of the drawings, the grip dispenser 50′ comprises a dispenser stand 52′ and a retention shaft 53′ upwardly extended from the dispenser stand 52′, wherein the elongated gripping sheet 10′ is retrievably rolled over the retention shaft 53′ for easy retrieval.

Finally, referring to FIG. 6A of the drawings, the grip dispenser 50 may be embodied as a wide variety of shapes so that the dispenser body 51 can be supported by a dispenser stand 52 for supporting the grip dispenser 50 in a wide variety of circumstances and for different uses. For example, the grip dispenser 50 may be provided in public places, such as in a bus, for convenient retrieval by the general public.

Alternatively, as shown in FIG. 6B of the drawings, the grip dispenser 50″ may comprise a dispenser stand 52″ and a retention shaft 53″ upwardly extended from the dispenser stand 52″, wherein the elongated gripping sheet 10″ is retrievably rolled over the retention shaft 53″ for easy retrieval.

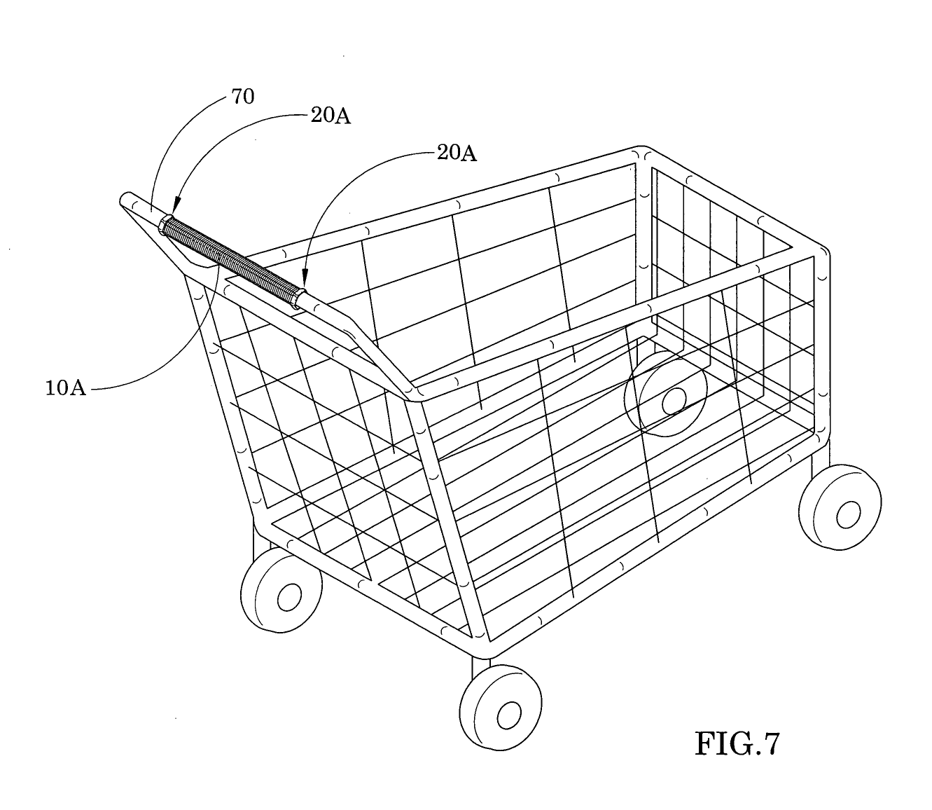

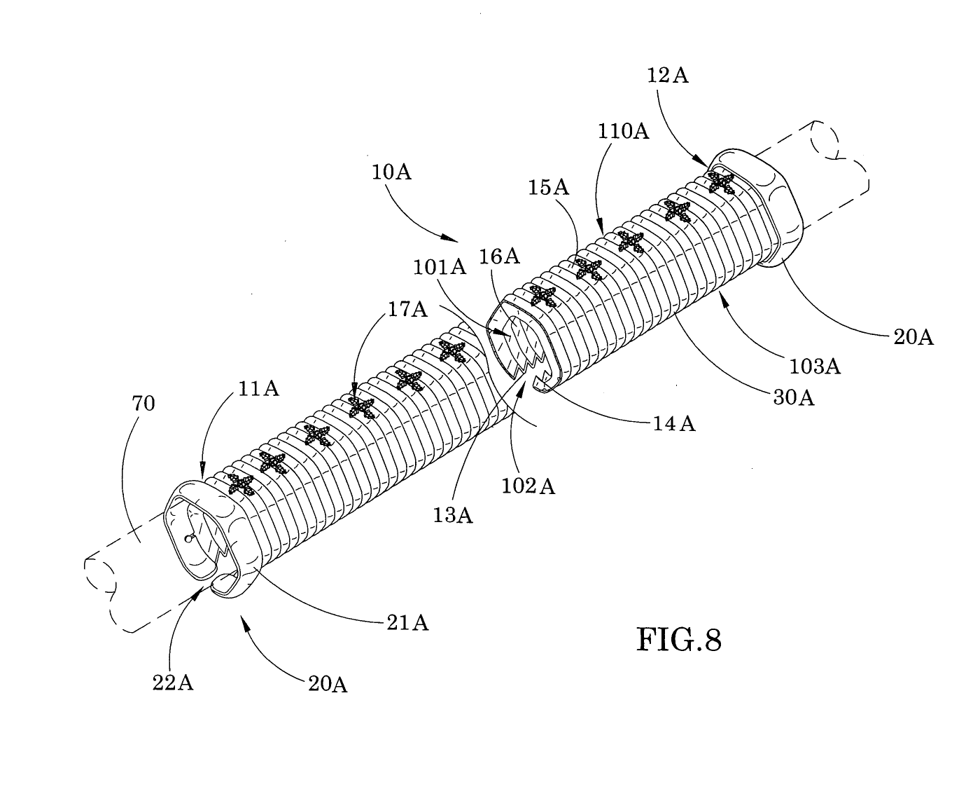

Referring to FIGS. 7 and 8, a handle bar grip arrangement of a second embodiment illustrates an alternative mode of the first embodiment of the present invention, wherein the handle bar grip arrangement comprises an elongated gripping sheet 10A and two holding rings 20A for mounting around a handle bar 70 such as a handle bar of a shopping cart as shown in FIG. 7.

As shown in FIG. 8, the gripping sheet 10A, which is made of germ-resistant material, has first and second longitudinal edges 11A, 12A defining a width of the gripping sheet 10A at least larger than the circumferential size of the handle bar 70, and first and second transverse edges 13A, 14A defining a length of the gripping sheet 10A at least larger than two-hand size of a user. The gripping sheet 10A is rolled to form a tubular wrap having a wrapping cavity 10A for receiving the handle bar 70 and elongated wrapping opening 102A formed between the first and second longitudinal edges 11A, 12A to communicate with the wrapping cavity 101A.

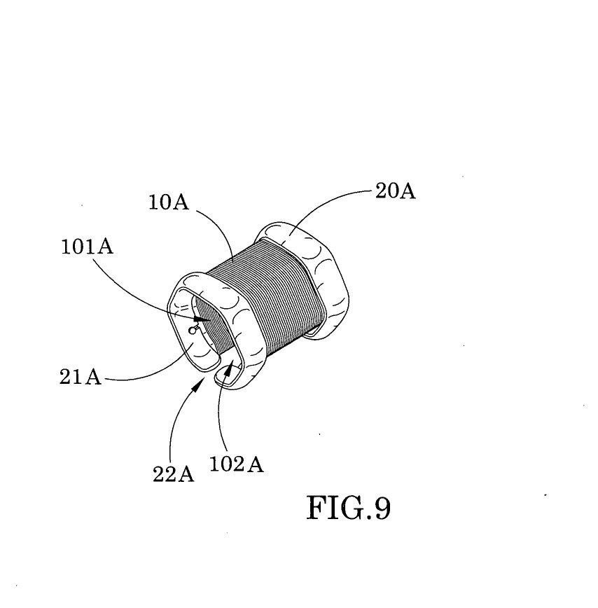

The two holding rings 20A, each having a C-shaped cross section, are provided at the first and second transverse edges 13A, 14A of the gripping sheet 10A respectively to fold the gripping sheet 10A from a retraction position to an extension position. At the retraction position, as shown in FIG. 9, the gripping sheet 10A is folded along the folding lines 110A to minimize a distance between the holding rings 20A. At the extension position, as shown in FIG. 8, the holding rings 20A are pulled at opposed directions to stretch out the gripping sheet 10A for wrapping around the handle bar 70.

Therefore, the user is able to warp the gripping sheet 10A around the handle bar 70 by detachably coupling the gripping sheet 10A in the retraction position through the wrapping opening 102A and sidewardly pulling the holding rings 20A along the handle bar 70 to stretch out the gripping sheet 10A, such that the gripping sheet 10A forms a germ barrier to resist the germ on the handle bar 70 being directly contacted with the hand of the user.

According to the second embodiment, the gripping sheet 10A is made of waterproof material, such as plastic, adapted to be cleaned after every usage. Therefore, the user is able to stretch out the gripping sheet 10A to clean the surface of the gripping sheet 10A by water or other sanitizing means.

The gripping sheet 10A further has a plurality of folding lines 10A evenly formed between the first and second transverse edges 13A, 14A. Accordingly, in order to fold the gripping sheet 10A between the two holding rings 20A, the folding lines 110A are pre-formed at the gripping sheet 10A between the two holding rings 20A. Therefore, when the gripping sheet 10A is folded at the retraction position, the gripping sheet 10A is folded in a zigzag manner.

As shown in FIG. 8, the handle bar grip arrangement further comprises a plurality of folding grids 30A provided at the folding lines 110A of the gripping sheet 10A respectively to guide and reinforce the gripping sheet 10A being folded at the retraction position. The folding grids 30A not only form as a reinforcing frame to retain the gripping sheet 10A in a tubular shape when the gripping sheet 10A is stretched at the extension position but also form as a guiding frame to guide the gripping sheet 10A being folded at the folding lines 110A at the retraction position.

Accordingly, the gripping sheet 10A has a plurality of folding sections 103A that each of the folding sections 103A is formed between every two of the folding grids 30A, such that the folding grids 30A reinforce the folding sections 103A being foldably overlapped with each other at the retraction position. Therefore, the folding sections 103A are guided to overlap with each other via the folding grids 30A so as to ensure the gripping sheet 10A being folded at the retraction position.

As shown in FIG. 8, the folding grids 30A are integrally formed at the folding lines 110A of the gripping sheet 10A respectively such that the gripping sheet 10A is adapted to be folded from the extension position back to the retraction position. As it is mentioned above, the gripping sheet 10A is made of waterproof material, preferably is made of plastic, wherein the folding grids 30A are integrated with the gripping sheet 10A to form a one piece structure. Accordingly, a thickness of the gripping sheet 10A at each of the folding lines 110A is larger than a thickness of the gripping sheet 10A at each of the folding sections 103A to form the folding grid 30A at the respective folding line 110A. In other words, by increasing the thickness of the gripping sheet 10A at the folding lines 110A, the folding grids 30A are integrally formed to guide and reinforce the gripping sheet 10A being folded at the retraction position. It is worth to mention that the gripping sheet 10A of the present invention is reusable that the user is able to stretch the gripping sheet 10A to encircle around the handle bar 70 and to retractably fold up the gripping sheet 10A for next time use.

As shown in FIG. 8, the gripping sheet 10A further has an outer gripping side 15A, an inner enclosure side 16A forming the wrapping cavity 101A therewithin, and a character coating 17A coated on the gripping side 15A such that when the gripping sheet 10A is stretched at the extension position, the character coating 17A is shown on the gripping sheet 10A along the handle bar 70. Accordingly, the character coating 17A can be a company logo or an artistic printing printed on the gripping side 15A of the gripping sheet 10A such that when the handle bar grip arrangement of the present invention is in use, the character coating 17A can be seen along the handle bar 70.

According to the second embodiment, each of the holding rings 20A has a flexible ring body 21A attaching to the respective transverse edge 13A, 14A of the gripping sheet 10A and having a thickness larger than a thickness of the gripping sheet 10A, and a mounting opening 22A aligning with the wrapping opening 102A and having a width smaller than a diameter of the handle bar 70, such that the ring bodies 21A are stretched for detachably fastening around the handle bar 70 through the mounting opening 22A to retain the gripping sheet 10A around the handle bar 70.

Accordingly, in order to mount the handle bar grip arrangement of the present invention along the handle bar 70, the user is able to stretch each of the holding rings 20A to widen the mounting openings 22A thereof to coaxially mount the holding rings 20A at the handle bar 70. Then, the user is able to outwardly and sidewardly pull the holding rings 20A apart to stretch out the gripping sheet 10A from the retraction position to the extension position. Therefore, the gripping sheet 10A will be encircled around the handle bar 70 to form the germ barrier so as to prevent the hands of the user directly contacting with the handle bar 70.

In order to detach the handle bar grip arrangement of the present invention from the handle bar 70, the user is able to push the holding rings 20A towards each other to retract the gripping sheet 10A back to the retraction position. Then, the user is able to detach the holding rings 20A from the handle bar 70. Alternatively, the user is able to detach the holding rings 20A from the handle bar 70 and then is able to retract the gripping sheet 10A back to the retraction position.

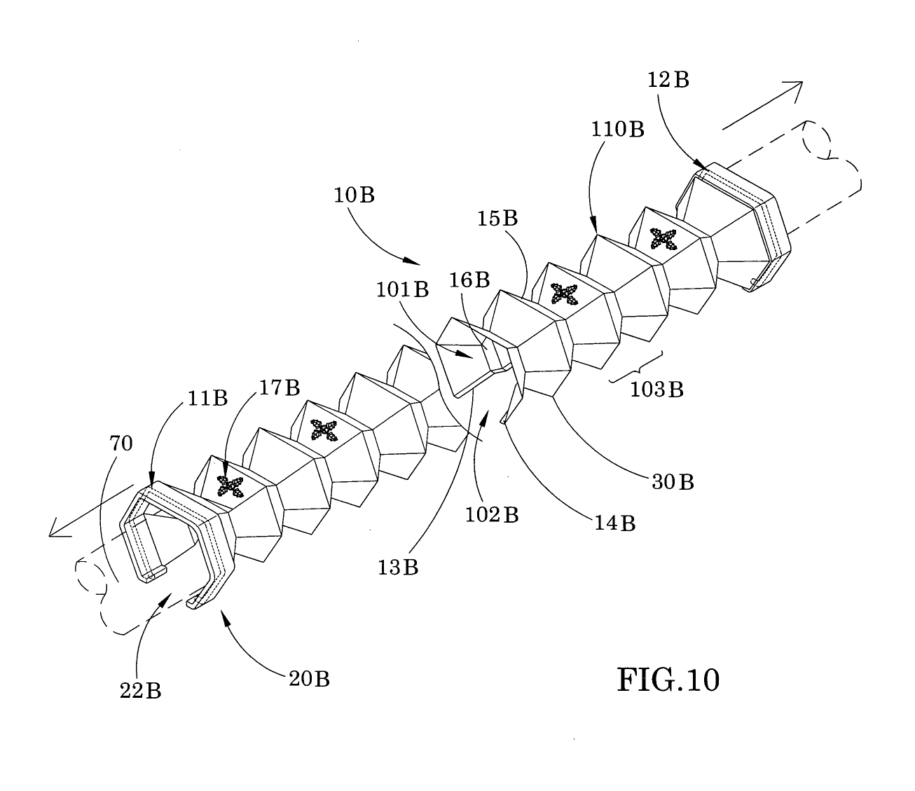

FIG. 10 illustrates an alternative mode of the handle bar grip arrangement of the second embodiment, wherein the handle bar grip arrangement comprises an elongated gripping sheet 10B made of germ-resistant material and two holding rings 20B.

The gripping sheet 10B has first and second longitudinal edges 11B, 12B defining a width of the gripping sheet 10B at least larger than the circumferential size of the handle bar 70, and first and second transverse edges 13B, 14B defining a length of the gripping sheet 10B at least larger than two-hand size of a user. The gripping sheet 10B is rolled to form a tubular wrap having a wrapping cavity 101B for receiving the handle bar 70 and elongated wrapping opening 102B formed between the first and second longitudinal edges 11B, 12B to communicate with the wrapping cavity 101B.

The two holding rings 20B, each having a C-shaped cross section, are provided at the first and second transverse edges 13B, 14B of the gripping sheet 10B respectively to fold the gripping sheet 10B from a retraction position to an extension position. At the retraction position, the gripping sheet 10B is folded along the folding lines 110B to minimize a distance between the holding rings 20B. At the extension position, the holding rings 20B are pulled at opposed directions to stretch out the gripping sheet 10B for wrapping around the handle bar 70. As shown in FIG. 10, the gripping sheet 110B is being stretched that when the gripping sheet 10B is stretched at the extension position, the gripping sheet 10B forms a flat sheet encircling around the handle bar 70.

The gripping sheet 110B further has a plurality of folding lines 110B evenly formed between the first and second transverse edges 13B, 14B. Accordingly, in order to fold the gripping sheet 10B between the two holding rings 20B, the folding lines 110B are pre-formed at the gripping sheet 10B between the two holding rings 20B. Therefore, when the gripping sheet 101B is folded at the retraction position, the gripping sheet 10B is folded in a zigzag manner. Accordingly, the gripping sheet 10B is made of sanitizing paper pre-folded at the retraction position.

The handle bar grip arrangement further comprises a plurality of folding grids 30B provided at the folding lines 110B of the gripping sheet 101B respectively to guide and reinforce the gripping sheet 10B being folded at the retraction position. The folding grids 30B not only form as a reinforcing frame to retain the gripping sheet 10B in a tubular shape when the gripping sheet 10B is stretched at the extension position but also form as a guiding frame to guide the gripping sheet 10B being folded at the folding lines 110B at the retraction position.

Accordingly, the gripping sheet 10B has a plurality of folding sections 103B that each of the folding sections 103B is formed between every two of the folding grids 30B, such that the folding grids 30B reinforce the folding sections 103B being foldably overlapped with each other at the retraction position. Therefore, the folding sections 103B are guided to overlap with each other via the folding grids 30B so as to ensure the gripping sheet 110B being folded at the retraction position.

The folding grids 30B are integrally formed at the folding lines 110B of the gripping sheet 10B respectively. Since the gripping sheet 10B is made of sanitizing paper, when the gripping sheet 110B is folded along the folding lines 110B, the folding edges of the gripping sheet 10B form the folding grids 30B. It is worth to mention that the alternative mode of the handle bar grip arrangement is a disposable germ protecting barrier that after using the gripping sheet 10B as the germ protecting barrier, the user is able to dispose the handle bar grip arrangement.

As shown in FIG. 10, each of the holding rings 20B comprises an elastic clip 21B having a C-shape to retain the gripping sheet 10B in a tubular shape, wherein the two transverse edges 13B, 14B of the gripping sheet 10B are attached to the two elastic clips 21B at the transverse edges 13B, 14B respectively.

Accordingly, each of the elastic clips 21B has a mounting opening 22B aligning with the wrapping opening 102B and has a width smaller than a diameter of the handle bar 70, such that the elastic clips 21B are stretched for detachably fastening around the handle bar 70 through the mounting openings 22B to retain the gripping sheet 10B around the handle bar 70.

The gripping sheet 10B further has an outer gripping side 15B, an inner enclosure side 16B forming the wrapping cavity 101B therewithin, and a character coating 17B coated on the gripping side 15B such that when the gripping sheet 10B is stretched at the extension position, the character coating 17B is shown on the gripping sheet 10B along the handle bar 70.

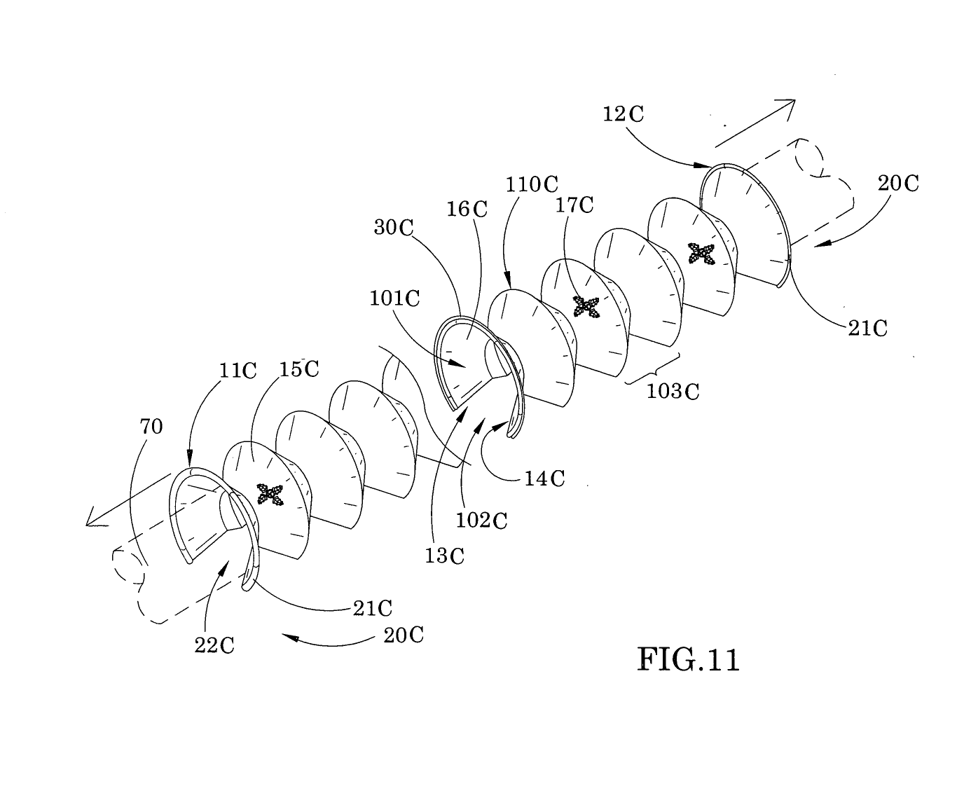

FIG. 11 illustrates another alternative mode the handle bar grip arrangement of the second embodiment, wherein the structure of the second alternative mode is the same as the first alternative mode except the guiding grids 30C and the material of the gripping sheet 10C.

The gripping sheet 10C has first and second longitudinal edges 11C, 12C defining a width of the gripping sheet 10C at least larger than the circumferential size of the handle bar 70, and first and second transverse edges 13C, 14C defining a length of the gripping sheet 10C at least larger than two-hand size of a user. The gripping sheet 10B is rolled to form a tubular wrap having a wrapping cavity 101C for receiving the handle bar 70 and elongated wrapping opening 102C formed between the first and second longitudinal edges 11C, 12C to communicate with the wrapping cavity 101C.

The two holding rings 20C, each having a C-shaped cross section, are provided at the first and second transverse edges 13C, 14C of the gripping sheet 10B respectively to fold the gripping sheet 10C from a retraction position to an extension position. At the retraction position, the gripping sheet 10C is folded along the folding lines 110C to minimize a distance between the holding rings 20C. At the extension position, the holding rings 20C are pulled at opposed directions to stretch out the gripping sheet 10C for wrapping around the handle bar 70. As shown in FIG. 11, the gripping sheet 10C is being stretched that when the gripping sheet 10C is stretched at the extension position, the gripping sheet 10C forms a flat sheet encircling around the handle bar 70.

The gripping sheet 10C further has a plurality of folding lines 110C evenly formed between the first and second transverse edges 13C, 14C. Accordingly, in order to fold the gripping sheet 10C between the two holding rings 20C, the folding lines 110C are pre-formed at the gripping sheet 10C between the two holding rings 20C. Therefore, when the gripping sheet 10C is folded at the retraction position, the gripping sheet 10C is folded in a zigzag manner. Accordingly, the gripping sheet 10B is made of sanitizing fabric pre-folded at the retraction position.

The handle bar grip arrangement further comprises a plurality of folding grids 30C provided at the folding lines 110C of the gripping sheet 10C respectively to guide and reinforce the gripping sheet 10C being folded at the retraction position. The folding grids 30C not only form as a reinforcing frame to retain the gripping sheet 10C in a tubular shape when the gripping sheet 10C is stretched at the extension position but also form as a guiding frame to guide the gripping sheet 10C being folded at the folding lines 110C at the retraction position.

Accordingly, the gripping sheet 10C has a plurality of folding sections 103C that each of the folding sections 103C is formed between every two of the folding grids 30C, such that the folding grids 30C reinforce the folding sections 103C being foldably overlapped with each other at the retraction position. Therefore, the folding sections 103C are guided to overlap with each other via the folding grids 30C so as to ensure the gripping sheet 10C being folded at the retraction position.

Each of the folding grids 30C comprises a C-shaped skeleton rim attached to the gripping sheet 10C at said respective folding line 110C to reinforce the gripping sheet 10C in a tubular shape when the gripping sheet 10C is stretched at the extension position. Preferably, each of the folding grids 30C is made of elastic material such as metal wire or plastic strip to retain the gripping sheet 10C in a tubular shape.

As shown in FIG. 10, each of the holding rings 20C comprises an elastic clip 21C having a C-shape to retain the gripping sheet 10C in a tubular shape, wherein the two transverse edges 13C, 14C of the gripping sheet 10B are rolled to embed the two elastic clips 21C at the transverse edges 13C, 14C respectively.

Accordingly, each of the elastic clips 21C has a mounting opening 22C aligning with the wrapping opening 102C and has a width smaller than a diameter of the handle bar 70, such that the elastic clips 21C are stretched for detachably fastening around the handle bar 70 through the mounting openings 22C to retain the gripping sheet 10C around the handle bar 70.

The gripping sheet 10C further has an outer gripping side 15C, an inner enclosure side 16C forming the wrapping cavity 101C therewithin, and a character coating 17C coated on the gripping side 15C such that when the gripping sheet 10C is stretched at the extension position, the character coating 17C is shown on the gripping sheet 10C along the handle bar 70.

One skilled in the art will understand that the embodiment of the present invention as shown in the drawings and described above is exemplary only and not intended to be limiting.

It will thus be seen that the objects of the present invention have been fully and effectively accomplished. Its embodiments have been shown and described for the purposes of illustrating the functional and structural principles of the present invention and is subject to change without departure from such principles. Therefore, this invention includes all modifications encompassed within the spirit and scope of the following claims.

What is claimed is:

1. A handle bar grip arrangement for a handle bar having a circumferential size, comprising:
an elongated gripping sheet, which is made of germ-resistant material, having first and second longitudinal edges defining a width of said gripping sheet at least larger than said circumferential size of said handle bar, and first and second transverse edges defining a length of said gripping sheet at least larger than two-hand size of a user, wherein said gripping sheet is rolled to form a tubular wrap having a wrapping cavity for receiving said handle bar and elongated wrapping opening formed between said first and second longitudinal edges to communicate with said wrapping cavity, wherein said gripping sheet further has a plurality of folding lines evenly formed between said first and second transverse edges; and
two holding rings, each having a C-shaped cross section, providing at said first and second transverse edges of said gripping sheet respectively to fold said gripping sheet from a retraction position to an extension position, wherein at said retraction position, said gripping sheet is folded along said folding lines to minimize a distance between said holding rings, and at said extension position, said holding rings are pulled at opposed directions to stretch out said gripping sheet for wrapping around said handle bar;
whereby, said user is able to warp said gripping sheet around the handle bar by detachably coupling said gripping sheet in said retraction position through said wrapping opening and sidewardly pulling said holding rings along said handle bar to stretch out said gripping sheet, such that said gripping sheet forms a germ barrier to resist the germ on the handle bar being directly contacted with the hand of the user.

2. The handle bar grip arrangement, as recited in claim 1, further comprising a plurality of folding grids provided at said folding lines of said gripping sheet respectively to guide and reinforce said gripping sheet being folded at said retraction position, wherein said gripping sheet has a plurality of folding sections that each of said folding sections is formed between every two of said folding grids, such that said folding grids reinforce said folding sections being foldably overlapped with each other at said retraction position.

3. The handle bar grip arrangement, as recited in claim 2, wherein said folding grids are integrally formed at said folding lines of said gripping sheet respectively such that said gripping sheet is adapted to be folded from said extension position back to said retraction position.

4. The handle bar grip arrangement, as recited in claim 3, wherein said gripping sheet is made of waterproof material adapted to be cleaned after every usage.

5. The handle bar grip arrangement, as recited in claim 1, wherein said gripping sheet has an outer gripping side, an inner enclosure side forming said wrapping cavity therewithin, and a character coating coated on said gripping side such that when said gripping sheet is stretched at said extension position, said character coating is shown on said gripping sheet along said handle bar.

6. The handle bar grip arrangement, as recited in claim 2, wherein said gripping sheet has an outer gripping side, an inner enclosure side forming said wrapping cavity therewithin, and a character coating coated on said gripping side such that when said gripping sheet is stretched at said extension position, said character coating is shown on said gripping sheet along said handle bar.

7. The handle bar grip arrangement, as recited in claim 4, wherein said gripping sheet has an outer gripping side, an inner enclosure side forming said wrapping cavity therewithin, and a character coating coated on said gripping side such that when said gripping sheet is stretched at said extension position, said character coating is shown on said gripping sheet along said handle bar.

8. The handle bar grip arrangement, as recited in claim 1, wherein each of said holding rings has a flexible ring body attaching to said respective transverse edge of said gripping sheet and having a thickness larger than a thickness of said gripping sheet, and a mounting opening aligning with said wrapping opening and having a width smaller than a diameter of said handle bar, such that said ring bodies are stretched for detachably fastening around said handle bar through said mounting opening to retain said gripping sheet around said handle bar.

9. The handle bar grip arrangement, as recited in claim 4, wherein each of said holding rings has a flexible ring body attaching to said respective transverse edge of said gripping sheet and having a thickness larger than a thickness of said gripping sheet, and a mounting opening aligning with said wrapping opening and having a width smaller than a diameter of said handle bar, such that said ring bodies are stretched for detachably fastening around said handle bar through said mounting opening to retain said gripping sheet around said handle bar.

10. The handle bar grip arrangement, as recited in claim 7, wherein each of said holding rings has a flexible ring body attaching to said respective transverse edge of said gripping sheet and having a thickness larger than a thickness of said gripping sheet, and a mounting opening aligning with said wrapping opening and having a width smaller than a diameter of said handle bar, such that said ring bodies are stretched for detachably fastening around said handle bar through said mounting opening to retain said gripping sheet around said handle bar.

11. The handle bar grip arrangement, as recited in claim 1, wherein said gripping sheet is made of sanitizing paper pre-folded at said retraction position.

12. The handle bar grip arrangement, as recited in claim 2, wherein said gripping sheet is made of sanitizing paper pre-folded at said retraction position.

13. The handle bar grip arrangement, as recited in claim 11, wherein each of said holding rings comprises an elastic clip having a C-shape to retain said gripping sheet in a tubular shape, wherein said two transverse edges of said gripping sheet are rolled to embed said two elastic clips at said transverse edges respectively.

14. The handle bar grip arrangement, as recited in claim 12, wherein each of said holding rings comprises an elastic clip having a C-shape to retain said gripping sheet in a tubular shape, wherein said two transverse edges of said gripping sheet are rolled to embed said two elastic clips at said transverse edges respectively.

15. The handle bar grip arrangement, as recited in claim 13, wherein each of said elastic clips has a mounting opening aligning with said wrapping opening and has a width smaller than a diameter of said handle bar, such that said elastic clips are stretched for detachably fastening around said handle bar through said mounting openings to retain said gripping sheet around said handle bar.

16. The handle bar grip arrangement, as recited in claim 14, wherein each of said elastic clips has a mounting opening aligning with said wrapping opening and has a width smaller than a diameter of said handle bar, such that said elastic clips are stretched for detachably fastening around said handle bar through said mounting openings to retain said gripping sheet around said handle bar.

17. The handle bar grip arrangement, as recited in claim 12, wherein said gripping sheet has an outer gripping side, an inner enclosure side forming said wrapping cavity therewithin, and a character coating coated on said gripping side such that when said gripping sheet is stretched at said extension position, said character coating is shown on said gripping sheet along said handle bar.

18. The handle bar grip arrangement, as recited in claim 16, wherein said gripping sheet has an outer gripping side, an inner enclosure side forming said wrapping cavity therewithin, and a character coating coated on said gripping side such that when said gripping sheet is stretched at said extension position, said character coating is shown on said gripping sheet along said handle bar.

19. The handle bar grip arrangement, as recited in claim 12, wherein each of said folding grids comprises a C-shaped skeleton rim attached to said gripping sheet at said respective folding line to reinforce said gripping sheet in a tubular shape when said gripping sheet is stretched at said extension position.

20. The handle bar grip arrangement, as recited in claim 18, wherein each of said folding grids comprises a C-shaped skeleton rim attached to said gripping sheet at said respective folding line to reinforce said gripping sheet in a tubular shape when said gripping sheet is stretched at said extension position.
